(19) United States
(12) Patent Application Publication
(10) Pub. No.: US 2016/0055846 A1
(43) Pub. Date: Feb. 25, 2016

(54) METHOD AND APPARATUS FOR SPEECH RECOGNITION USING UNCERTAINTY IN NOISY ENVIRONMENT

(71) Applicant: Electronics and Telecommunications Research Institute, Daejeon (KR)

(72) Inventors: Ho-Young JUNG, Daejeon (KR); Hwa-Jeon SONG, Daejeon (KR)

(21) Appl. No.: 14/465,001

(22) Filed: Aug. 21, 2014

(51) Int. Cl. G10L 15/20

(52) U.S. Cl. CPC G10L 15/20

(57) ABSTRACT

A method for speech recognition in accordance with the present invention includes: extracting a speech feature from an inputted speech signal; estimating a noise component of the speech signal; compensating the extracted speech feature by use of the estimated noise component; transforming a given acoustic model based on the extracted speech feature, the compensated speech feature, and the noise component; and performing speech recognition by use of the compensated speech feature and the transformed acoustic model.

### CROSS-REFERENCE TO RELATED APPLICATIONS

This application claims the benefit of Korean Patent Application No. 10-2013-0130299, filed with the Korean Intellectual Property Office on Oct. 30, 2013, the disclosure of which is incorporated herein by reference in its entirety.

### BACKGROUND

1. Technical Field

The present invention relates to a method and an apparatus for speech recognition in a noisy environment, more specifically to a method and an apparatus for speech recognition using uncertainty in a noisy environment.

2. Background Art

Two major noise processing technologies used for speech recognition are the feature compensation technique and the model adaptation technique. The feature compensation technique, which improves extracted features for speech recognition, is a pre-processing procedure for obtaining clean voice features by removing noise components from speech features contaminated by noise. The model adaptation technique transforms an acoustic model to make an adapted model become as if it is learned from the present speech that is mixed with noise. In the model adaptation technique, a noise acoustic model is generated by making the acoustic model adapted by use of presumed noise components, and speech recognition is performed using this noise acoustic model.

The feature compensation technique is based on the assumption that the noise can be perfectly presumed, but its performance is inevitably limited due to errors in the presumption of noise. With the model adaptation technique, it is difficult to generate the acoustic model whenever speech recognition is performed for an inputted speech, and its real time application is difficult in a dynamic noise environment where noise features change with time.

### SUMMARY

The present invention provides a method and an apparatus for speech recognition that combine the feature compensation technique and the model adaptation technique, generate a noise acoustic model reflecting uncertainty in accordance with a remaining noise component in a process of presuming speech features from which a noise component is removed through feature compensation, and perform speech recognition by use of the noise acoustic model.

A method for speech recognition in accordance with the present invention includes: extracting a speech feature from an inputted speech signal; estimating a noise component of the speech signal; compensating the extracted speech feature by use of the estimated noise component; transforming a given acoustic model based on the extracted speech feature, the compensated speech feature, and the noise component; and performing speech recognition by use of the compensated speech feature and the transformed acoustic model.

The method for speech recognition also includes determining an average movement component of Gaussian distribution for the given acoustic model by use of a difference between the extracted speech feature and the compensated speech feature, and in the step of transforming, the given acoustic model is transformed by use of the determined average movement component.

In the step of transforming, the given acoustic model can be transformed by adding the determined average movement component to an average of Gaussian distribution for the acoustic model.

In the step of determining, the average movement component can be determined by use of an average movement model implemented by pre-learning an optimal value of the average movement component in accordance with the difference between the speech feature contaminated by noise and the noise-compensated speech feature based on collected noise data.

In the step of transforming, the given acoustic model can be transformed by adding a variance of the noise component to a variance of Gaussian distribution for the given acoustic model.

The method for speech recognition can also include creating speech frames by separating the speech signal with a prescribed length, and in the step of extracting, a speech feature can be extracted from each of the speech frames.

In the step of estimating, a noise component can be estimated in each of the speech frames, and in the step of transforming, the given acoustic model can be transformed for each of the speech frames.

An apparatus for speech recognition in accordance with the present invention includes: a speech feature extraction portion configured to extract a speech feature from an inputted speech signal; a noise component estimation portion configured to estimate a noise component of the speech signal; a feature compensation portion configured to compensate the extracted speech feature by use of the estimated noise component; a model transformation portion configured to transform a given acoustic model based on the extracted speech feature, the compensated speech feature, and the noise component; and a speech recognition portion configured to perform speech recognition by use of the compensated speech feature and the transformed acoustic model.

The apparatus for speech recognition also includes an average movement determining portion configured to determine an average movement component of Gaussian distribution for the given acoustic model by use of the difference between the extracted speech feature and the compensated speech feature, and the model transformation portion can transform the given acoustic model by use of the determined average movement component.

The model transformation portion can transform the given acoustic model by adding the determined average movement component to an average of Gaussian distribution for the given acoustic model.

The average movement determining portion can determine the average movement component by use of an average movement model implemented by pre-learning an optimal value of the average movement component in accordance with the difference between the speech feature contaminated by noise and the noise-compensated speech feature based on collected noise data.

The model transformation portion can transform the given acoustic model by adding a variance of the noise component to a variance of Gaussian distribution for the given acoustic model.

The apparatus for speech recognition can also include a frame creation portion configured to create speech frames by separating the speech signal with a prescribed length, and the speech feature extraction portion can extract a speech feature from each of the speech frames.

The noise component estimation portion estimates a noise component for each of the speech frames, and the model transformation portion can transform the given acoustic model for each of the speech frames.

### BRIEF DESCRIPTION OF THE DRAWINGS

FIG. 1 is a block diagram of an apparatus for speech recognition in accordance with an embodiment of the present invention.

FIG. 2 is a flowchart of a method for speech recognition in accordance with an embodiment of the present invention.

### DETAILED DESCRIPTION

Hereinafter, embodiments of the present invention will be described in detail with reference to drawings. In the descriptions and accompanying drawings hereinafter, identical or corresponding elements will be given the same reference numerals thereby avoiding duplicated descriptions. Also if well-known functions or structures related to the present invention are determined to distract the point of the present invention, the pertinent detailed explanations will be omitted.

The embodiments of the present invention can be realized through diverse means. For example, the embodiments of the present invention can be realized as hardware, firmware, software, or a combination of them.

When it is realized by hardware, a method of the embodiments of the present invention can be constructed by one or more of ASIC (application specific integrated circuit), DSP (digital signal processor), DSPD (digital signal processing device), PLD (programmable logic device), FPGA (field programmable gate array), processor, controller, micro controller, microprocessor, and the like.

When it is realized by firmware or software, the method of the embodiments of the present invention can be constructed as a module, a procedure, a function, and the like which performs the described functions or operations. Software codes can be stored in a memory unit and be performed by a processor. The memory unit as being located inside or outside of the processor can exchange data with the processor.

Performing a speech recognition in an environment where various dynamic noises exist is very difficult because a user's speech, the subject to be recognized is diversely contaminated by noises. As described before, the feature compensation technique that estimates a clean sound feature from a contaminated speech feature and the model adaptation technique that adapts an acoustic model in a speech recognition device to a noise acoustic model have been widely used, but have many problems to be used effectively in a speech recognition system in a real environment.

When various dynamic noises exist, the feature compensation technique has a problem of inevitably having remaining noise because estimating a noise component thoroughly from a speech signal mixed with noise is impossible. The model adaptation technique is not also suitable for an environment where a noise component varies all the time because gaining an accurate acoustic model for the noise environment is difficult and re-composing the entire acoustic model every moment gives a system a big load.

The present invention suggests a method and a apparatus combining the following two methodologies. First one is to estimate a remaining noise component after applying the feature compensation to a speech signal as an uncertainty, and the second one is generating a noise acoustic model which considers the remaining noises by use of the uncertainty.

Generally, a basic procedure to perform the speech recognition can be represented as the following mathematical equation 1.

$$\hat{W} = arg {max}_{W} \{ P ( W \vert {X}_{1 : T} ) \} = arg {max}_{W} \{ P ( W ) P ( {X}_{1 : T} \vert W ) \} \\ P ( {X}_{1 : T} \vert W ) = {\sum }_{{q}_{1 : T}} P ( {X}_{1 : T} \vert {q}_{1 : T} , W ) P ( {q}_{1 : T} \vert W ) \qquad [ Mathematical Equation 1 ]$$

Wherein, Ŵ, W, X_{1:T}, and q_{1:T}, denote a recognized words array, a words array, an input speech feature (feature vector), and an acoustic model parameter respectively. And 1:T means ‘from time 1 to T’. Namely, according to the mathematical equation 1, the recognized words array Ŵ is given by the words array when the multiplication of a probability of words array and a conditional probability of the speech feature X_{1:T} that is inputted to the acoustic model of the words array is maximum value.

If the input speech X_{1:T} is contaminated by noise, the speech recognition process can be represented as the following mathematical equation 2.

$$[ Mathematical Equation 2 ]$$

$$\hat{W} = arg {max}_{W} \{ P ( W \vert {Y}_{1 : T} ) \}$$

$$\begin{matrix}P ( W \vert {Y}_{1 : T} ) = {\int }_{R} P ( W \vert {X}_{1 : T} ) P ( {X}_{1 : T} \vert {Y}_{1 : T} ) d {X}_{1 : T} \\ = P ( W ) {\int }_{R} \frac{P ( {X}_{1 : T} \vert W )}{P ( {X}_{1 : T} )} P ( {X}_{1 : T} \vert {Y}_{1 : T} ) d {X}_{1 : T} \\ = P ( W ) {\sum }_{{q}_{1 : T}} {\int }_{R} \frac{P ( {X}_{1 : T} \vert {Y}_{1 : T} ) P ( {X}_{1 : T} \vert {q}_{1 : T} )}{P ( {X}_{1 : T} )} d {X}_{1 : T} P ( {q}_{1 : T} \vert W )\end{matrix}$$

Where, R denotes all values that the speech feature X_{1:T} can take.

When the feature compensation is performed, an estimated clean speech feature \hat{X}_{1:T} can be applied instead of X_{1:T} in the mathematical equation 2. Here, an uncertainty of the clean speech feature estimation can be represented as P(X_{1:T}|Y_{1:T}), and it denotes an uncertainty observation value. The conventional speech recognition methods ignoring the uncertainty observation value is based on an assumption that there are no errors in the feature compensation. However, errors of the feature compensation exist inevitably, so in the other conventional speech recognition methods for considering this, the uncertainty value is represented as a variance of \hat{X}_{1:T} and is applied to a variance of an acoustic model having Gaussian distribution. The embodiment of the present invention suggests a new method of estimating the uncertainty observation value P(X_{1:T}|Y_{1:T}). The conventional speech recognition methods represent an effect that an arbitrary sound phoneme space is spread by an effect of noise as an increment in a variance of an acoustic model. In the embodiment of present invention, the acoustic model is adapted more accurately to the effect of noise to be utilized for speech recognition in a noise environment.

The part including the uncertainty observation value in the mathematical equation 2 will be approximated as the following mathematical equation 3.

$${\sum }_{{q}_{1 : T}} {\int }_{R} \frac{P ( {X}_{1 : T} \vert {Y}_{1 : T} ) P ( {X}_{1 : T} \vert {q}_{1 : T} )}{P ( {X}_{1 : T} )} d {X}_{1 : T} \approx {\sum }_{{q}_{1 : T}} P ( {\hat{X}}_{1 : T} \vert {q}_{1 : T} ) P ( {X}_{u} \vert {Y}_{1 : T} ) \qquad [ Mathematical Equation 3 ]$$

With reference to the mathematical equation 3, if a denominator is ignored as being considered as a value for normalization, a value for integration can be represented as a speech feature \hat{X}_{1:T} that is not contaminated by noise, which is estimated through MMSE (Minimum Mean Square Error) technique, and a component for an estimated error by MMSE is represented as P(Xᵤ|Y_{1:T}). Where, P(Xᵤ|Y_{1:T}) can be an observation value representing an uncertainty of an process for estimating the clean speech. The point estimation of a conventional MMSE process represents the uncertainty observation by Gaussian distribution that considers the variance of noise only in an assumption that it was relatively accurate and errors were distributed around the estimated point. However, since most of the estimated values gained through MMSE have errors, the embodiment of the present invention uses the Gaussian distribution which considers an average movement and a variance by noise based on the estimated value. This makes the acoustic model be adapted more accurately to the effect of noise.

In the embodiment of the present invention, the following mathematical equation 4 is applied to the speech recognition process in the mathematical equation 2 by modeling the uncertainty observation value P(Xᵤ|Y_{1:T}) of low credibility with Gaussian distribution.

$$[ Mathematical Equation 4 ]$$

$$\begin{matrix}P ( W \vert {Y}_{1 : T} ) = P ( W ) {\sum }_{{q}_{1 : T}} P ( {\hat{X}}_{1 : T} \vert {q}_{1 : T} ) P ( {X}_{u} \vert {Y}_{1 : T} ) P ( {q}_{1 : T} \vert W ) \\ = P ( W ) {\sum }_{{q}_{1 : T}} 𝒩 ( {\hat{X}}_{1 : T} ; {μ}_{q} + {μ}_{u} , {σ}_{q}^{2} + {σ}_{n}^{2} ) P ( {q}_{1 : T} \vert W )\end{matrix}$$

Where, μ_{q} and σ_{q}² denote an average and a variance of Gaussian distribution for a given acoustic model, and σₙ² denotes a variance of noise component. And μᵤ denotes a component of average movement of Gaussian distribution for the acoustic model due to an error in estimating a clean speech feature.

That is, the mathematical equation 4 means that it considers the average movement of Gaussian distribution due to an error in estimating the speech feature further than only adjusting the variance of Gaussian distribution from noises. With reference to the mathematical equation 4, the variance for the noise component is added to the variance of the given Gaussian distribution, and the average movement due to the error in estimating the clean speech feature is added to the average of the given Gaussian distribution.

An average movement component μᵤ of Gaussian distribution due to an error in estimating the speech feature can be determined by use of a difference between a contaminated speech feature Y_{1:T} and an estimated clean speech feature \hat{X}_{1:T}. If the difference is small, the estimated error can be considered to be small since the speech has not been contaminated much from the noise. On the contrary, if the difference is large, the estimated error can be considered to be large since the speech has been contaminated much. Therefore, as the difference between the contaminated speech feature Y_{1:T} and the estimated clean speech feature \hat{X}_{1:T}. is large, the average movement component μᵤ of Gaussian distribution is determined to have a large value, and as the difference is small, it is determined to have a small value. The value of the average movement component μᵤ determined by the difference between the contaminated speech feature Y_{1:T} and the estimated clean speech feature \hat{X}_{1:T} can be applied after collecting noise data in the environments to be applied to the speech recognition system and pre-learning it with an optimal value.

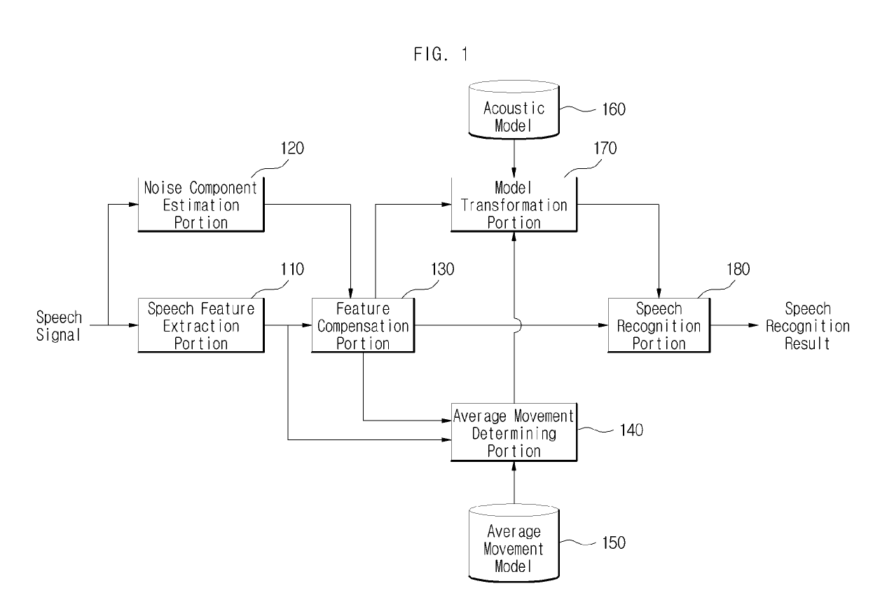

FIG. 1 is a block diagram of an apparatus for speech recognition in accordance with an embodiment of the present invention.

A speech feature extraction portion 110 extracts a speech feature to be used for the speech recognition from an inputted speech signal. Although it is not illustrated, a frame creation portion can separate the speech signal into 20 msec or 30 msec length speech frame in every 10 msec, and the speech feature extraction portion 110 can extract a feature vector from each of the speech frames. As speech vector, MFCC, mel-frequency cepstrum coefficients can be used. The speech feature extracted from the speech feature extraction portion 110 is a speech feature contaminated by noise.

A noise component estimation portion 120 estimates a noise component from an inputted speech signal. Here the noise component estimation portion 120 is able to estimate a noise component for each of the created speech frames.

A feature compensation portion 130 compensates the speech feature by use of the noise component estimated by the noise component estimation portion 120. That is, the feature compensation portion 130 estimates a clean speech feature from which the noise component is eliminated from the speech feature extracted by the speech feature extraction portion 110. The feature compensation portion 130 can use, for example, the well-known Interactive Multiple Model (IMM) technique as the feature compensation technique.

An average movement determining portion 140 determines an average movement component of Gaussian distribution for an acoustic model by use of the difference between the speech feature contaminated by noise extracted from the speech feature extraction portion 110 and the clean speech feature estimated through the feature compensation portion 130. In order to determine the average movement component, the apparatus for speech recognition in accordance with the present embodiment collects noise data in various environments and is equipped with an average movement model 150 implemented by pre-learning an optimal value of the average movement component in accordance with the difference between the speech feature contaminated by noise and the estimated clean speech feature namely, the noise-compensated speech feature. Therefore, the average movement determining portion 140 determines the average movement component of Gaussian distribution for the acoustic model based on the average movement model 150 by use of the difference between the speech feature contaminated by noise extracted from the speech feature extraction portion 110 and the clean speech feature estimated through the feature compensation portion 130.

An acoustic model 160 as being pre-given consists of a plurality of Gaussian distributions.

A model transformation portion 170 transforms the acoustic model 160 by use of the noise component estimated by the noise component estimation portion 120 and the average movement component determined by the average movement determining portion 140. The model transformation portion 170 transforms the acoustic model 160 by adding a variance of the estimated noise component to the variance of Gaussian distribution of the acoustic model 160 and adding the determined average movement component of Gaussian distribution of the acoustic model 160. The acoustic model transformed by the model transformation portion 170 is an acoustic model in which an uncertainly of the speech feature estimation is reflected, in other word, an acoustic model in which an uncertainly in accordance with a remaining noise component is reflected.

A speech recognition portion 180 receives an input of the clean speech feature estimated through the feature compensation portion 130, performs the speech recognition based on the acoustic model transformed through the model transformation portion 170, and outputs a result of the speech recognition. After all, the speech recognition portion 180 performs the speech recognition based on the mathematical equation 2 and the mathematical equation 4.

The determination of the average movement component of Gaussian distribution for the acoustic model by the average movement determining portion 140, and the transformation of the acoustic model 160 by the model transformation portion 170 can be performed for each of the speech frames in real time. In this case, the speech recognition can be performed based on the acoustic model in which the uncertainty in accordance with a remaining noise component is reflected in real time.

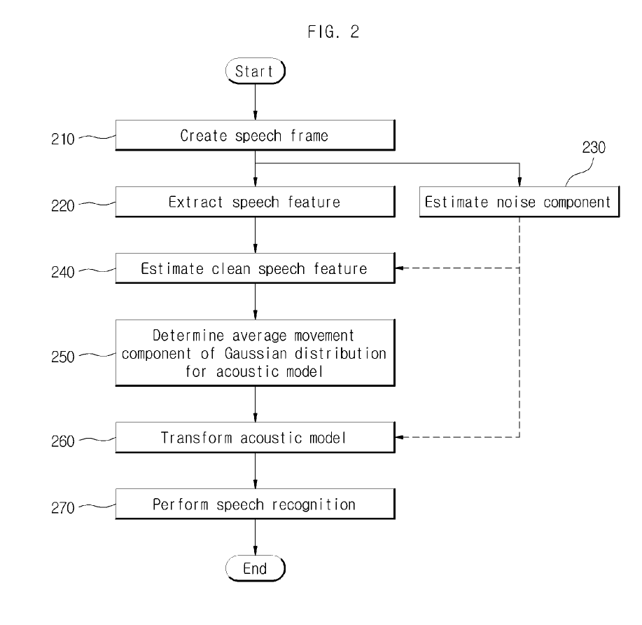

FIG. 2 is a flowchart of a method for speech recognition in accordance with an embodiment of the present invention. A method for speech recognition in accordance with the present embodiment comprises steps to be processed in the speech recognition apparatus described above. Therefore, contents described for the speech recognition apparatus above will be applied to the method for speech recognition in accordance with the present embodiment even though some of them are omitted.

In step 210, the apparatus for speech recognition separates an inputted speech signal to 20 msec or 30 msec length in every 10 msec roughly and creates speech frames.

In step 220, the apparatus for speech recognition extracts a speech feature from each of the speech frames to be used in the speech recognition. The speech feature extracted at step 220 is a speech feature contaminated by noise.

In step 230, the apparatus for speech recognition estimates a noise component from the inputted speech signal. Here, the noise component can be estimated for each of the speech frames created through step 210.

In step 240, the apparatus for speech recognition estimates a clean speech feature from which the noise component is removed from the speech feature contaminated by noise based on the noise component estimated in step 230.

In step 250, the apparatus for speech recognition determines an average movement component of Gaussian distribution for an acoustic model by use of the difference between the speech feature contaminated by noise and the estimated clean speech feature. Here, in order to determine the average movement component, the apparatus collects noise data in various environments and can use an average movement model 150 implemented by pre-learning with an optimal value of the average movement component in accordance with the difference between the speech feature contaminated by noise and the estimated clean speech feature.

In step 260, the apparatus for speech recognition transforms the pre-given acoustic model 160 by use of the determined average movement component and a variance of the estimated noise component. Specifically, the apparatus transforms the acoustic model 160 by adding the variance of the estimated noise component to the variance of Gaussian distribution of the acoustic model 160 and adding the determined average movement component to the average of Gaussian distribution of the acoustic model 160.

In step 270, the apparatus for speech recognition performs the speech recognition with the clean speech feature estimated through step 240 and by use of the acoustic model transformed through step 260.

The embodiments of the present invention can be written as a program being able to run on a computer, and can be realized by digital computers executing the programs by use of computer-readable media. The computer-readable media includes a semiconductor memory such as ROM, RAM and the like, magnetic recording media such as Floppy Disk, Hard Disk, and the like, and optical recording media such as CD-ROM, DVD, etc.

The present invention is described with reference to embodiments. It will be understood by those who skilled in the art that the present invention can be realized in various forms not departing from the essential features of the present invention. Therefore the disclosed embodiments should be considered not for being restrictive but for being illustrative. The protected scope of the present invention shall be understood by the scope of claims below not by the explanations above, and all differences residing in the equivalent scope shall be included in the rights of the present invention.

What is claimed is:

1. A method for speech recognition, comprising:
extracting a speech feature from an inputted speech signal;
estimating a noise component of the speech signal;
compensating the extracted speech feature by use of the estimated noise component;
transforming a given acoustic model based on the extracted speech feature, the compensated speech feature, and the noise component; and
performing speech recognition by use of the compensated speech feature and the transformed acoustic model.

2. The method of claim 1, further comprising determining an average movement component of Gaussian distribution for the given acoustic model by use of a difference between the extracted speech feature and the compensated speech feature,
wherein, in the step of transforming, the given acoustic model is transformed by use of the determined average movement component.

3. The method of claim 2, wherein, in the step of transforming, the given acoustic model is transformed by adding the determined average movement component to an average of Gaussian distribution for the acoustic model.

4. The method of claim 2, wherein, in the step of determining, the average movement component is determined by use of an average movement model implemented by pre-learning an optimal value of the average movement component in accordance with the difference between the speech feature contaminated by noise and the noise-compensated speech feature based on collected noise data.

5. The method of claim 1, wherein, in the step of transforming, the given acoustic model is transformed by adding a variance of the noise component to a variance of Gaussian distribution for the given acoustic model.

6. The method of claim 1, further comprising creating speech frames by separating the speech signal with a prescribed length,
wherein, in the step of extracting, a speech feature is extracted from each of the speech frames.

7. The method of claim 6, wherein, in the step of estimating, a noise component is estimated for each of the speech frames, and in the step of transforming, the given acoustic model is transformed for each of the speech frames.

8. An apparatus for speech recognition, comprising:
a speech feature extraction portion configured to extract a speech feature from an inputted speech signal;
a noise component estimation portion configured to estimate a noise component of the speech signal;
a feature compensation portion configured to compensate the extracted speech feature by use of the estimated noise component;
a model transformation portion configured to transform a given acoustic model based on the extracted speech feature, the compensated speech feature, and the noise component; and
a speech recognition portion configured to perform speech recognition by use of the compensated speech feature and the transformed acoustic model.

9. The apparatus of claim 8, further comprising an average movement determining portion configured to determine an average movement component of Gaussian distribution for the given acoustic model by use of the difference between the extracted speech feature and the compensated speech feature,
wherein the model transformation portion is configured to transform the given acoustic model by use of the determined average movement component.

10. The apparatus of claim 9, wherein the model transformation portion is configured to transform the given acoustic model by adding the determined average movement component to an average of Gaussian distribution for the given acoustic model.

11. The apparatus of claim 9, wherein the average movement determining portion is configured to determine the average movement component by use of an average movement model implemented by pre-learning an optimal value of the average movement component in accordance with the difference between the speech feature contaminated by noise and the noise-compensated speech feature based on collected noise data.

12. The apparatus of claim 8, wherein the model transformation portion is configured to transform the given acoustic model by adding a variance of the noise component to a variance of Gaussian distribution for the given acoustic model.

13. The apparatus of claim 8, further comprising a frame creation portion configured to create speech frames by separating the speech signal with a prescribed length,
wherein the speech feature extraction portion is configured to extract a speech feature from each of the speech frames.

14. The apparatus of claim 13, wherein the noise component estimation portion is configured to estimate a noise component for each of the speech frames, and the model transformation portion is configured to transform the given acoustic model for each of the speech frames.
